(19) United States
(12) Patent Application Publication
(10) Pub. No.: US 2018/0257949 A1
(43) Pub. Date: Sep. 13, 2018

(54) APPARATUS AND METHOD TO MAKE WATER DRINKABLE

(71) Applicant: SMART AQUAE SRL, Tavagnacco (IT)

(72) Inventor: Anes SBUELZ, Fiumicello (IT)

(21) Appl. No.: 15/757,426

(22) PCT Filed: Aug. 25, 2016
(86) PCT No.: PCT/IB2016/055073

§ 371 Date: Mar. 5, 2018

(30) Foreign Application Priority Data
Sep. 4, 2015 (IT) 102015000048752

(51) Int. Cl. C02F 1/04; C02F 1/10; B01D 1/14; B01D 5/00

(52) U.S. Cl. CPC C02F 1/048; C02F 1/10; C02F 2103/08; B01D 5/006; B01D 5/0054; B01D 1/14

(57) ABSTRACT

An apparatus to make water drinkable includes a tank (12) for the water to be made drinkable. A lower part (12a) of the tank contains the water to be made drinkable and an upper part (12b) is configured to accumulate the damp air. The tank also includes a hot air inlet (21) positioned in correspondence with the lower part (12a) and an exit pipe (19) for the damp air. The apparatus also includes a condensation unit (16) located in cooperation with the tank (12).

### FIELD OF THE INVENTION

The present invention concerns an apparatus and a method to make water drinkable, in particular an apparatus and method for purifying sea water, waste water, also from sewer systems, or in any case non-drinking water, eliminating pollutants, dirt or other, making it drinkable.

### BACKGROUND OF THE INVENTION

Plants and apparatuses are known for purifying and desalinizing water to obtain drinking water, for example purification apparatuses are known that can be classified in the following types:

ionic exchange, but these must be cleaned frequently and are not efficient in the case of high salt concentrations;

electro-dialysis, but these are very expensive because they need high quantities of energy;

inverse osmosis, but these have high costs due both to the cost of the membranes and also to the high cost of disposing of them as special waste, as well as the cost of the electric energy needed for running.

From document WO-A-2013/107469 a desalinization plant is also known using distillation to purify the salt water, eliminating the solids dissolved therein and making it drinkable. This known apparatus comprises a “hot” area where the water contained in a casing is evaporated and water vapor is generated, and a “cold” area where the water vapor is condensed.

However, the apparatus is complex and complicated, limited in its production due to the limits of temperatures imposed by the heat pumps and air streams achievable, and is not easy to maintain.

Other plants to make water drinkable using evaporation are known from JP-A-2001259616, US-A1-2010032280 and DE-U1-20301711.

JP-A-2001259616 describes an apparatus for producing drinking water from undrinkable water sources such as lakes, rivers, seas, comprising a cooling circuit and a pump to create a vacuum. The solution described in JP-A-2001259616 provides to use the pump to create the vacuum in a tank containing the water to be made drinkable to make the water evaporate and obtain water vapor, and the cooling circuit to condense the vapor obtained and thus obtain drinking water. However, this apparatus only allows a limited volumetric transport of vapor and a relatively low water temperature, limited by the characteristics of the heat-carrier fluid of the cooling circuit. Moreover, the apparatus described in JP-A-2001259616 does not provide any recirculation of the vapor from which the drinking water has been removed, in order to be able to re-use it to force the generation of damp air in the tank.

US-A1-2010032280 describes a tower-like structure with two chambers, of which one is a hot heating chamber and the other a cold condensation chamber, usable to make seawater drinkable. The water to be made drinkable is introduced into the tower together with ambient air, with which it is mixed; the air, at ambient temperature, absorbs humidity when in contact with the water, and is conveyed toward the condensation chamber, where water-type condensation means are provided that condense the damp air and allow to obtain drinking water. Since cooling reduces pressure and heating increases pressure, a convective motion is obtained from the hot chamber to the cold chamber. The condensation means are water-type cooling means which provide to use cold water taken from deep in the sea. The apparatus described is therefore bulky and complex. Furthermore, it does not provide any tank to collect the water to be made drinkable, or any recirculation of the air from which the water has been removed in order to force the generation of damp air.

DE-U1-20301711 describes a heat evaporation apparatus for treating seawater or waste water to obtain drinking water. The apparatus comprises a boiler that contains the water to be treated, which is heated through combustion or with heated elements inside the boiler. The water that evaporates on the surface of the body of water rises upward and condenses in correspondence with a heat exchange surface of the container, from which it is collected by means of suitable pipes. The solution described in DE-U1-20301711 provides to force the evaporation of the water to be treated, and to obtain the necessary heat exchange for the condensation by conveying a stream of air to cool the condensation surface. It does not provide any recirculation of the air from which the condensation has been removed inside the water to be made drinkable in order to force the generation of vapor.

There is therefore a need to perfect an apparatus and method to make water drinkable that can overcome at least one of the disadvantages of the solutions described above, and more generally allow to obtain a greater efficiency in making water drinkable compared with state-of-the-art solutions.

In particular, one purpose of the present invention is to obtain an apparatus to make water drinkable which is simple to run and compact in size, so that it can be used also for domestic uses and/or in small communities, such as for example condominiums, hotels, residences or even individual houses.

Another purpose of the present invention is to obtain an apparatus to make water drinkable which is transportable.

Another purpose of the present invention is to obtain an apparatus to make water drinkable which needs simple and little maintenance, in which materials and devices normally used in a domestic environment can be used, and simple apparatuses for drawing the water to be made drinkable.

Another purpose is to perfect a method to make water drinkable which is efficient and versatile.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes, an apparatus to make water drinkable provides a tank to accumulate the water to be made drinkable.

The accumulation tank comprises a lower part, configured to contain the water to be made drinkable for a determinate portion thereof, and an upper part, configured to define an accumulation chamber of the damp air of a sufficient size to contain the nebulization of the water in the ways explained hereafter.

The accumulation tank can also comprise inlet means of hot air, disposed in correspondence to the lower part, and at least an exit pipe for the damp air, disposed in correspondence with the upper part.

The apparatus also comprises a condensation unit, configured to condense the damp air and to produce condensation of clean water and air at a temperature close to ambient temperature.

The condensation unit is located in cooperation with the accumulation tank through the damp air exit pipe, through which the damp air accumulated in the upper part of the accumulation tank is introduced into the condensation unit.

The condensation unit has a heat exchange and recovery section, and a cooling section, or condensation section, which is associated with a tank to collect condensation.

The condensation unit is configured to use the heat generated by the phase change (vapor-water) in order to heat the air before introducing it into the accumulation tank.

In particular, the air that is heated is the same air that exits from the condensation section, near to ambient temperature and hence saturated with humidity at its own temperature.

This allows to recirculate the air without dispersing humidity into the environment, and to introduce air into the accumulation tank at a temperature a little lower than that of the saturated damp air exiting from the accumulation tank. Furthermore, it reduces possible contaminations from the environment, limiting the need for complex air filtering systems in the environment where the apparatus according to the present invention is operating.

The physical phenomenon on which the apparatus according to the present invention operates concerns the latent heat due to the phase change of the water from vapor to liquid. A slight reduction in the temperature of the hot air, saturated with humidity, can cause a significant rise in the temperature of the cold condensation air, taking it to temperatures even a few degrees higher than that of the environment.

According to some embodiments, the heat exchange and recovery section and the condensation section are air-air heat exchangers which can use ambient air.

According to some embodiments, the apparatus to make water drinkable described above comprises or is associated with a renewable energy source. The renewable energy source can be a wind power source, solar cells or a solar water heating unit, and can cooperate with the accumulation tank to heat the water contained therein and produce damp air.

According to a variant, any kind of energy power is provided.

The saturated damp air in the upper part of the accumulation tank is made to transit in the heat exchange and recovery section, where clean air taken from the outside, which has previously transited in the condensation section with ambient temperature air, transits in counter-current.

The saturated damp air in the heat exchange and recovery section and condensation section with ambient air gives up heat to the air taken from outside, heating it, and as it gives up heat it is disassociated from the humidity with which it is soaked, and gets rid of it.

The air which has lost its humidity, reducing its temperature in the condensation section, follows a forced path, passing again in the heat exchange and recovery section, to be heated again.

The air heated in the heat exchange and recovery section is sent to the accumulation tank under the level of the liquid head of the water to be made drinkable, so as to spread inside it under the level of the liquid head, saturating with humidity and transferring into the upper part of the accumulation tank.

The humidity condenses and is collected in the condensation collection tank.

According to some embodiments, a heating device can be provided, configured to increase the production of water vapor.

According to some variant embodiments, a circuit for heating the water can be present in the tank, configured to heat the water to be made drinkable so as to obtain damp air, and which can comprise an upper heat exchange device and a lower heat exchange device.

According to possible embodiments, a diffuser element can be disposed between the upper heat exchange device and the lower heat exchange device.

Advantageously, with this configuration, it is possible to create a physical phenomenon due to the process of air humidification and to the heat absorbed for the phase change of the water (liquid-vapor). This entails a first absorption of heat and a reduction in temperature of the mass of water under the diffuser element, in which the greatest absorption of humidity occurs, and a further absorption of humidity due to the rise in temperature in the mass of water above the diffuser element. In this way the absolute humidity in the air is maximized in the upper part of the accumulation tank to the temperature of the water in the tank.

The heating circuit, with the two heat exchange devices, disposed as described above, allows to keep the mass of water to be made drinkable at a temperature such as to damp the bacterial load, for example a temperature comprised between about 40° C. and 60° C., preferably between 45° C. and 50° C.

This configuration of the heating circuit also allows to maximize the concentration of water in the form of humidity compatibly with the temperatures admissible in domestic heating plants, for example between about 50° C. and about 80° C., and to maintain a descending convective motion so as to promote the decantation of possible solids dissolved in the water to be made drinkable and the possible powders contained in the air.

The heating circuit also allows to keep the damp air in the upper part of the tank at a temperature above 60° C.

Due to the configuration described above, the apparatus according to the invention forces the heated air introduced into the accumulation tank containing the water to be saturated with humidity at a temperature above ambient temperature, even more than 60° C., so that for the condensation it is enough to use air at ambient temperature, without needing to provide cooling systems for the damp air.

According to variant embodiments, combinable with all the embodiments described here, the apparatus according to the present invention can also include a control and command unit.

In some variants, the control and command unit can be connected to a remote data transmission network of any known type, through which it can communicate with a server able to store and possibly to process the data detected on each occasion in real time, with all the management parameters of the apparatus. The server can act in feedback on part or all the functions of the apparatus.

Possible examples can be radio data transmission networks, either short-, medium- or long-range, by Wi-Fi or GSM protocols, or Bluetooth® or Zigbee protocol, or NFC (Near Field Communication) protocol, or infrared communication protocol (for example Infrared Data Association, or IrDA).

According to another variant, a display interface can be provided, on which, through the remote data transmission network, possible signals of malfunction of the apparatus can be displayed, and/or warnings of programmed maintenance interventions.

According to another variant, the malfunction signals and/or maintenance warnings can be sent remotely to a user.

The apparatus can be completely integrated in a single component, the sizes of which can be determined by the hourly productivity of drinking water to be obtained.

The accumulation tank is also associated with discharge and periodic cleaning means, to eliminate the materials that sediment on the bottom.

In association with the accumulation tank it is also possible to provide means to introduce inertization elements suitable to flocculate possible dangerous substances, such as oils for example or other fatty and/or oily substances.

According to a variant embodiment, it can be provided that the condensation unit cooperates with a system to further damp bacteria or viruses, which provides to introduce chlorine or other disinfectant, or to use UV-A rays inside the pipes where the water passes.

According to a possible variant embodiment, in association with the condensation collection tank, a tank is provided to evaporate possible solvents and/or another tank, which can be associated with means to add integrating substances such as minerals or other substances associable with the human body.

The purified water is controlled and, if there are other corpuscles, it is made to pass in ultra-filtering units to eliminate them completely.

Downstream of the condensation collection tank and the possible additive means or disinfectant means, means can be provided to introduce salts and vitamins into the purified water, so as to make it more suitable for use by a user.

The various aspects and characteristics described in the present description can be applied individually where possible. These individual aspects, for example aspects and characteristics described in the description or in the attached dependent claims, can be the object of divisional applications.

It is understood that any aspect or characteristic that is discovered, during the patenting process, to be already known, shall not be claimed and shall be the object of a disclaimer.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a schematic view of an apparatus to make water drinkable according to embodiments described here;

FIG. 2 is a detail of a part of the apparatus to make water drinkable in FIG. 1;

FIG. 3 is a detail of a part of the apparatus to make water drinkable in FIG. 1;

FIG. 4 is a block diagram of the method to control the apparatus according to embodiments described here.

To facilitate comprehension, the same reference numbers have been used, where possible, to identify identical common elements in the drawings. It is understood that elements and characteristics of one embodiment can conveniently be incorporated into other embodiments without further clarifications.

### DETAILED DESCRIPTION OF SOME EMBODIMENTS

We shall now refer in detail to the various embodiments of the present invention, of which one or more examples are shown in the attached drawing. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall include all such modifications and variants.

Before describing these embodiments, we must also clarify that the present description is not limited in its application to details of the construction and disposition of the components as described in the following description using the attached drawings. The present description can provide other embodiments and can be obtained or executed in various other ways. We must also clarify that the phraseology and terminology used here is for the purposes of description only, and cannot be considered as limitative.

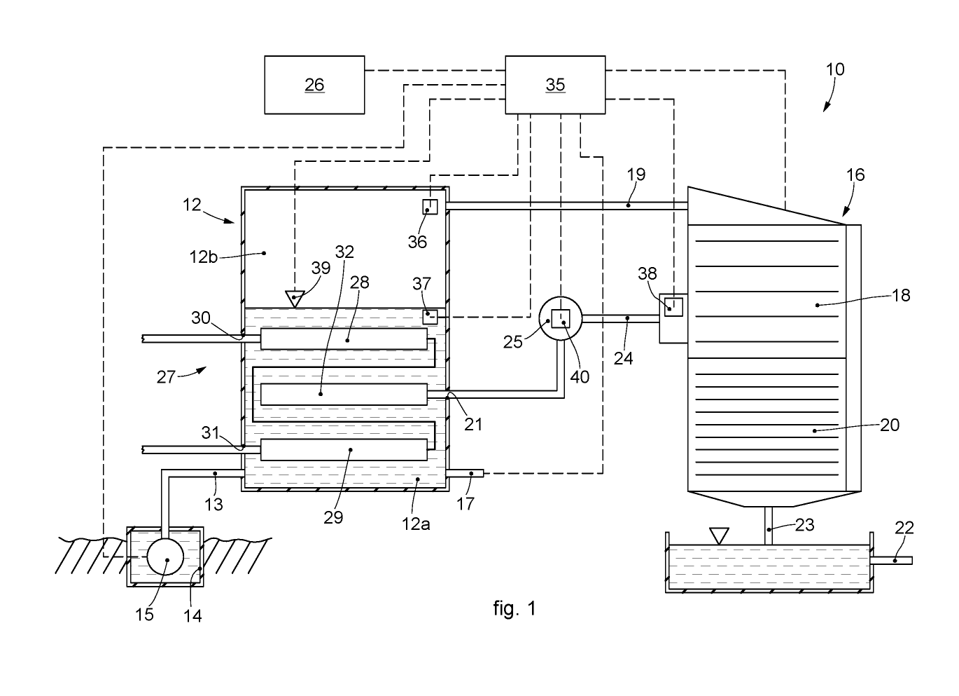

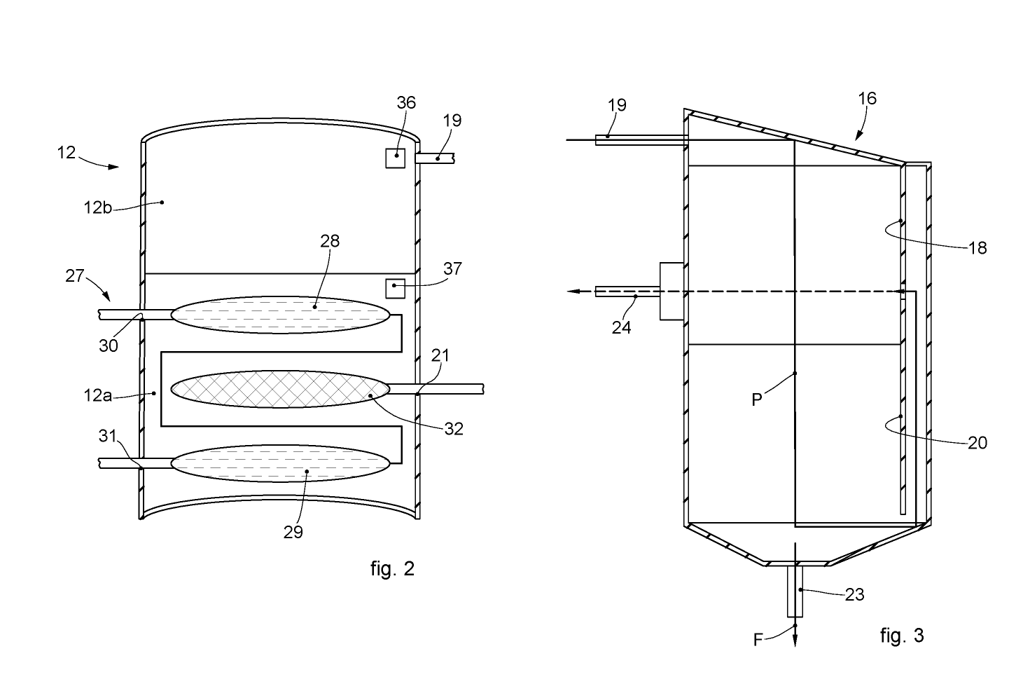

In accordance with the above purposes, embodiments described using FIGS. 1 and 2 concern an apparatus 10 to make water drinkable. The apparatus 10 can be used to treat seawater or waste water, also from sewer systems, or more generally non-drinking water of any type, eliminating pollutants, dirt or other from it, in order to make it drinkable or in any case usable for any use whatsoever.

The apparatus 10 provides a containing and/or accumulation tank 12, hereafter simply tank 12, for the water to be made drinkable, which can be hermetically sealed during use.

The water accumulated in the tank 12 can contain salt for example, pollutants, bacterial load or solid residues, which make it undrinkable and not suitable for use by a user.

According to some embodiments, the tank 12 comprises a lower part 12a configured to contain the water to be made drinkable for a determinate vertical portion, and an upper part 12b, configured to define an accumulation chamber for the damp air that is big enough and in any case correlated in size with the quantity of water contained in the lower part and intended to be made drinkable.

According to some embodiments, the tank 12 comprises at least an entrance pipe 13 for the water to be made drinkable; the pipe 13 can take water directly from the sea, or can be connected to a well 14, for example by means of an immersion pump 15, to take water from a water table.

According to some embodiments, the entrance pipe 13 for the water to be made drinkable may not need filters during pick-up, since possible solid residues are decanted onto the bottom of the tank 12 and can be removed during the programmed emptying operations.

According to some embodiments, the tank 12 can also comprise at least one exit pipe 17 for the water to a discharge tank, or dilution tank, for example to reduce the concentration of salts from the water before sending it to the sea or a water table, for example to perform periodic maintenance.

According to some embodiments, valves can be provided to selectively open/close respectively the entrance pipe 13 and/or the exit pipe 17 of the water to/from the tank 12.

According to some embodiments, the tank 12 also comprises means to blow in hot air, configured to heat the water present in the tank 12.

The tank 12 can comprise a hot air inlet 21, which can be associated with the blowing means, positioned in correspondence with the lower part 12a of the tank 12.

The hot air inlet 21 can be for example an aperture or a passage pipe for hot air.

In some embodiments, the hot air inlet 21 can be positioned for example under the minimum level of the water to be made drinkable that is present during the normal functioning of the apparatus 10 in the tank 12.

According to a possible solution, the hot air inlet 21 can be positioned for example about half-way along the vertical extension of the lower part 12a.

The hot air introduced into the water contained in the tank 12 absorbs humidity and transports a determinate mass of water in the form of damp air into the upper part 12b of the tank 12. In this way the formation of damp air is forced at a temperature corresponding to that of the water present in the tank 12.

The tank 12 also comprises a damp air exit pipe 19, which can be positioned in the upper part 12b of the tank 12 to allow the damp air to exit.

The apparatus 10 also comprises a condensation unit 16, located in cooperation with the tank 12, for example by means of the damp air exit pipe 19.

The condensation unit 16 is configured to receive the damp air generated in the tank 12, and to condense it, separating it into condensed water and heated air.

According to some embodiments, a pipe 24 for heated air is provided, which connects the condensation unit 16 to the hot air inlet 21 to allow the heated air to flow from the condensation unit 16 to the tank 12.

According to some embodiments, the condensation unit 16 comprises a heat exchange and recovery section 18 and a condensation section 20, configured to progressively cool and dry the damp air arriving from the tank 12.

According to one solution, the heat exchange and recovery section 18 and the condensation section 20 can be heat exchangers of the air-air type, in which the damp air arriving from the tank 12 can flow in counter-current with ambient air taken from outside the condensation unit 16.

According to embodiments described using FIGS. 1 and 3, the damp air arriving from the tank 12 is made to transit through the heat exchange and recovery section 18, partly cooling and giving up heat to the air flowing in counter-current.

Subsequently, the partly cooled damp air passes through the condensation section 20 in which it gives up heat to the air taken from the outside, giving up condensation. The condensed water vapor precipitates toward the bottom of the condensation section 20 in direction F (FIG. 3).

According to some embodiments, a condensation collection tank 22 can be provided (FIG. 1) associated, for example by means of an exit pipe for purified water 23, with the condensation section 20.

Moreover, according to some embodiments, the pipe 24 for the heated air is associated with the heat exchange and recovery section 18.

In these embodiments, the air with reduced absolute humidity exiting from the condensation section 20 is made to circulate forcedly again in the heat exchange and recovery section 18, in which it is again heated before being made to exit through the pipe 24 for the heated air.

According to embodiments described using FIG. 3, the air, from the damp air exit pipe 19 to the pipe 24 for the heated air, follows a forced path P.

According to some embodiments, the condensation unit 16 is configured to use the heat of the phase change (vapor-water) to heat the air toward the pipe 24 for the heated air, before introducing it into the tank 12 through the hot air inlet 21.

According to some embodiments, an air movement unit 25 is provided, disposed along the pipe 24 for the heated air, such as a fan, or an air suction pump. The air movement unit 25 is configured to move, for example by sucking it in, the air heated by the heat exchange and recovery section 18, and to introduce it at a desired pressure into the tank 12.

According to some embodiments, the circuit of air along the forced path P under normal working conditions is substantially a closed circuit, except in the start-up and heating phase. When the air movement unit 25 is inoperative, the volatile substances, due to the rise in temperature, are able to exit from the tank 12, which prevents them from spreading in the condensation water.

The air heated in the heat exchange and recovery section 18 is sent to the tank 12 under the level of the liquid head of the water to be made drinkable, so as to spread into one or more points under the level of the liquid head, and then rises upward, taking with it water vapor which tends to saturate the upper part 12b of the tank 12.

According to some embodiments, downstream of the pipe 24 for the heated air a diffuser element 32 can be provided, disposed inside the tank 12, and associated with the hot air inlet 21, configured to convey the air uniformly over the whole surface of the water, so as to prevent nebulization and hence the transport of water with its contents into the damp air and hence into the condensation unit 16.

According to some embodiments, the apparatus 10 comprises a renewable energy source 26, located in cooperation at least with the tank 12.

According to some embodiments, the renewable energy source 26 can comprise one or more of either a wind power generator, solar cells with a photovoltaic effect, or a solar water heating unit, for example with solar panels or solar concentration.

According to possible embodiments, the apparatus 10 can be completely powered by the electric energy supplied by the renewable energy source 26.

According to a variant embodiment, not shown, the apparatus 10 can be connected to a traditional electric power network, and be powered by it.

According to some embodiments, a circuit 27 for heating the water can be present in the tank 12.

According to embodiments described using FIGS. 1 and 2, the heating circuit 27 can comprise an upper heat exchange device 28, disposed near the level of the liquid head.

According to embodiments described using FIGS. 1 and 2, the heating circuit 27 also comprises a lower heat exchange device 29, disposed near the bottom of the tank 12.

According to an embodiment described using FIGS. 1 and 2, the diffuser element 32 can be disposed between the upper heat exchange device 28 and the lower heat exchange device 29.

According to possible solutions, the upper heat exchange device 28 and the lower heat exchange device 29 are coils connected to each other, in which a heating liquid flows, for example water.

According to some embodiments, the tank 12 is provided with an entrance aperture 30 for the heating liquid, associated with the upper heat exchange device 28, and an exit aperture 31 for the heating liquid, associated with the lower heat exchange device 29.

In this way, the heating liquid enters through the entrance aperture 30, passes through the upper heat exchange device 28 and the lower heat exchange device 29 and exits through the exit aperture 31.

According to some embodiments, the heating liquid can be heated to a desired temperature using the energy produced by the renewable energy source 26.

According to embodiments described using FIG. 1, the apparatus 10 also comprises a control and command unit 35, configured to regulate the functioning of the apparatus 10 at least to keep the temperature levels optimal to make the water drinkable, adapting to the available energy conditions, for example based on the energy available from the renewable energy source 26.

According to some embodiments, the apparatus 10 can comprise temperature detectors 36, 37, 38.

In particular, a first temperature detector 36 can be provided, disposed in the upper part 12b of the tank that functions as an accumulation tank for the damp air and configured to detect the temperature of the damp air accumulated therein.

A second temperature detector 37 can also be provided, positioned in the lower part 12a of the tank 12 and configured to detect the temperature of the water to be made drinkable.

A third temperature detector 38 can also be provided, positioned in the pipe 24 for the heated air, to detect the temperature of the heated recirculated air.

According to a possible solution, the apparatus 10 can also comprise a detector 39 to detect the level of liquid, configured to detect the level of the water to be made drinkable in the tank 12.

According to another possible solution, the apparatus 10 also comprises a detector to detect the flow rate of heated air, configured to detect the flow rate of air along the pipe 24 for the heated air.

According to embodiments described using FIG. 1, the control and command unit 35 is connected to and receives data from one, several or all the temperature detectors 36, 37, 38, the level detector 39, flow rate detector 40 and external energy source 26, and according to the data received, regulates the functioning of the apparatus 10.

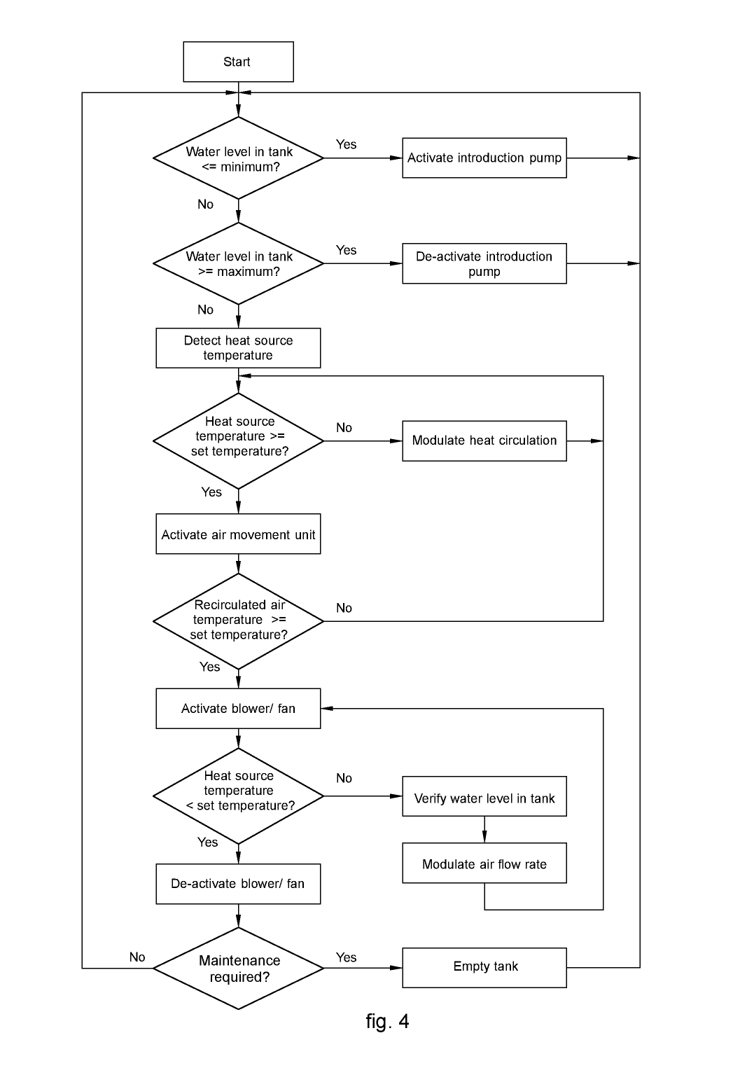

According to embodiments described using FIG. 4, the control and command unit 35 can receive an indication of the level of liquid in the tank 12 from the level detector 39 and can compare it with a predetermined minimum level and maximum level. If the level of the liquid is lower than the minimum level, the control and command unit 35 activates the immersion pump 15 to take water to be made drinkable from the sea or well 14. Vice versa, if the level of the liquid is higher than the maximum level, the control and command unit 35 de-activates the immersion pump 15.

If necessary, the control and command unit 35 can command the opening of the exit pipe 17 to discharge at least part of the liquid from the tank 12 to take it under the maximum level.

According to some embodiments, the control and command unit 35 can be configured to receive data relating to the temperature of the liquid in the tank 12 by means of the second temperature detector 37 and relating to the temperature of the damp air by means of the first temperature detector 36, and to compare them with the temperature of the recirculated air detected by the third temperature detector 38.

According to some embodiments, the control and command unit can detect the temperature of the heat source, for example detecting the energy supplied by the renewable energy source 26, or the heating temperature of the liquid in the heating circuit 27.

Based on this comparison, the control and command unit 35 can therefore regulate the heating circuit 27 and/or the air movement unit 25 to regulate respectively the temperature of the liquid in the tank 12 and the air flow rate through the air movement unit 25 in order to keep a desired temperature difference between the temperature of the damp air exiting from the tank 12 and the temperature of the heated air entering the tank 12.

For example, if the temperature of the heating circuit 27 is lower than a set value, it can regulate the air flow rate to keep the temperature levels of the water and damp air at the desired levels.

If the temperature of the heating circuit 27 is greater than or equal to the set value, then the control and command unit 35 activates the air movement unit 25.

Subsequently, the control and command unit 35 can verify if the temperature of the heated air, detected by the temperature detector 38, is greater than or equal to a set value. If so, the air movement unit 25 remains active, until the temperature of the heat source becomes lower than the reference value set, in which case the air movement unit 25 is de-activated. If the temperature of the heat source is greater than or equal to the reference value set, then the control and command unit 35 makes a new comparison of the level of water with the respective minimum and maximum values, and possibly modulates the flow rate of heated air.

Moreover, if it is necessary to actuate maintenance operations, the control and command unit 35 can possibly de-activate the air movement unit 25 and the heating circuit 27 and open the exit pipe 17 to empty the tank 12.

According to possible variant embodiments, the control and command unit 35 comprises a memorization unit configured to memorize the data detected by the detectors 36, 37, 38, 39, 40 and/or the set data for the functioning of the apparatus 10.

It is clear that modifications and/or additions of parts may be made to the apparatus and method to make water drinkable as described heretofore, without departing from the field and scope of the present invention.

It is also clear that, although the present invention has been described with reference to some specific examples, a person of skill in the art shall certainly be able to achieve many other equivalent forms of apparatus and method to make water drinkable, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1.-11. (canceled)

12. Apparatus to make water drinkable, comprising a tank (12) to accumulate and/or contain the water to be made drinkable, wherein said tank (12) comprises:
a lower part (12a) to contain the water to be made drinkable,
an upper part (12b) to accumulate damp air,
a hot air inlet (21) positioned in correspondence with said lower part (12a),
at least one exit pipe (19) for the damp air positioned in said upper part (12b) to allow the damp air to exit,
said apparatus further comprising a condensation unit (16) configured to condense said damp air and separate the condensation into clean water and heated air, said condensation unit (16) being connected to said tank (12) by means of said damp air exit pipe (19) and by means of a pipe (24) for the heated air connected to said hot air inlet (21),
wherein said pipe (24) for the heated air defines a path for said heated air from said condensation unit (16) to said tank (12), and
wherein a forced path (P) for the air is provided from the damp air exit pipe (19) to the pipe (24) for the heated air.

13. Apparatus according to claim 12, wherein said condensation unit (16) comprises a heat exchange and recovery section (18) and a condensation section (20).

14. Apparatus according to claim 13, wherein said heat exchange and recovery section (18) and said condensation section (20) are air-air heat exchangers.

15. Apparatus according to claim 12, further comprising a source of renewable energy (26).

16. Apparatus according to claim 12, further comprising a diffuser element (32) disposed inside said tank (12), associated with said hot air inlet (21) and configured to convey the air uniformly over the whole surface of the water.

17. Apparatus according to claim 12, wherein in the lower part (12a) of said tank (12), there is a circuit (27) to heat the water to be made drinkable, and configured to keep the temperature of the water between about 40° C. and 60° C.

18. Apparatus according to claim 17, wherein said heating circuit (27) comprises an upper heat exchange device (28) configured to keep the damp air in the tank (12) at a temperature of more than or equal to 60° C.

19. Apparatus according to claim 16, wherein the heating device (27) further comprises a lower heat exchange device (29) and wherein said upper heat exchange device (28) is disposed above said diffuser element (32) and said lower heat exchange device (29) is disposed below said diffuser element (32).

20. Apparatus according to claim 12, further comprising a control and command unit (35) configured to regulate the functioning of the apparatus at least to keep the optimum temperature levels to make the water drinkable, adapting to the energy conditions available.

21. Method to make the water contained in a tank (12) drinkable, the method comprising:
accumulating water to be made drinkable in a lower part (12a) of said tank (12);
introducing hot air through a hot air inlet (21) positioned in said lower part (12a) to reduce the absorption of heat from the accumulated water and to produce damp air in an upper part (12b) of said tank (12);
transferring said damp air through a damp air exit pipe (19) positioned in said upper part (12b) to allow the damp air to exit into a condensation unit (16);
condensing said damp air arriving from said damp air exit pipe (19) in said condensation unit (16) and produce condensation of clean water and heated air; and
sending said heated air by means of a pipe (24) for the heated air into said tank (12) under the level of the water to be made drinkable through said hot air inlet (21),
wherein said method provides to make the damp air from the damp air exit pipe (19) to the pipe (24) for the heated air following a forced path (P) in said condensation unit (16) to be dried to remove the water from it and to be heated before introducing it into said tank (12) through said hot air inlet (21).

22. Method according to claim 21, further comprising heating said water to be made drinkable in said tank (12) by means of a heating circuit (27).
